(19) United States
(12) Patent Application Publication
(10) Pub. No.: US 2009/0127191 A1
(43) Pub. Date: May 21, 2009

(54) PROCESS FOR TREATING A SOLID-LIQUID MIXTURE

(75) Inventor: Anthony Francis Collings, Turramurra (AU)

Correspondence Address: SUGHRUE MION, PLLC, 2100 PENNSYLVANIA AVENUE, N.W., SUITE 800, WASHINGTON, DC, 20037, US

(73) Assignee: COMMONWEALTH SCIENTIFIC AND INDUSTRIAL RESEARCH ORGANISATION, CAMPBELL, AUSTRIALIAN CAPITAL TERRITORY (AU)

(21) Appl. No.: 12/090,573

(22) PCT Filed: Oct. 20, 2006
(86) PCT No.: PCT/AU2006/001558

§ 371 Date: Aug. 6, 2008

(30) Foreign Application Priority Data
Oct. 20, 2005 (AU) 2005905803

(51) Int. Cl. C02F 3/02; C02F 11/02

(52) U.S. Cl. 210/620; 210/150

(57) ABSTRACT

A process is disclosed for treating a mixture of a solid and a liquid, the mixture including a contaminant. The process comprises the step of subjecting the mixture to cavitation wherein at least a portion of the contaminant is chemically decomposed. The process subsequently comprises the step of introducing a pre-determined biological species into the treated mixture to give a desired biological outcome, such as a biodegradation treatment, remediation or decomposition of the contaminant. Such a dual process can reduce the concentration of a contaminant to extremely low levels as well as achieve outcomes that the introduction of a biological species alone is not able to achieve.

### FIELD OF THE INVENTION

The present invention relates to a process for treating a contaminated solid and liquid mixture. The method can be applied to the decontamination of liquids such as water and/or solids such as soils or other substrates containing contaminants such as polychlorinated biphenyl (PCB) compounds, polycyclic aromatic hydrocarbon (PAH) compounds and pesticides such as organophosphate (OP) compounds, for example. This decontamination can be used in domestic, municipal or industrial applications and will primarily be described with reference to this context. However, it is to be appreciated that the invention has broader use in the decontamination of all manner of hazardous materials including but not limited to polybrominated biphenyl (PBB), organochlorides, pesticides and the like, and can be used in situations where heavy metals (eg selenium, arsenic etc) are present and also require treatment.

### BACKGROUND ART

Polychlorinated biphenyls (PCB compounds) were first discovered to be environmental pollutants in 1966. They have been found throughout the world in water, solid sediments, and bird and fish tissue. There are hundreds of different PCB compounds available, made by substituting from 1 to 10 chlorine atoms onto a biphenyl aromatic structure. PCB compounds have very high chemical, thermal and biological stability, and a low water solubility and vapour pressure. While these useful properties contributed to their widespread use, those same properties allowed these compounds to be accumulated in the environment.

The manufacture of PCB compounds was discontinued in the United States in 1979, although these compounds continue to enter the environment from discarded electrical equipment, and so on. PCB concentrations of 1-2 ppm are normally the desired maxima, and levels of 10-50 ppm in agricultural soils, clays or marine sediments are considered hazardous. The dense and hydrophobic nature of PCB compounds ensures that their accumulation in river sediment is commonplace, leading to bioaccumulation in bottom dwellers and fish thus leading to entry into the human food chain. PCB compounds can reduce human disease resistance, and increase the incidence of rashes, liver ailments and headaches, as can related compounds such as polybrominated biphenyls (PBB).

Polycyclic aromatic hydrocarbon (PAH) compounds are major contaminants of concern at manufactured gas plant sites such as gasworks. Several of those PAHs with more than four aromatic rings are regulated known carcinogens. PAHs in general have very low water solubility and bind tightly to soil or sediment constituents such as natural organic matter. In spite of their low solubility, PAHs can still can result in significant water toxicity and contamination.

Similarly, pesticides and insecticides can have serious health effects on humans and animals. Pesticides such as organophosphates (OP), carbaryl, synthetic pyrethroids and endosulfan as well as herbicides such as thiobencarb, molinate and others can accumulate and persist in the environment. Typically these pesticides are used in agriculture and find their way into rivers and streams and contaminate the downstream drinking water supply.

Numerous investigations of ways to degrade pesticides, PAH and PCB compounds have been carried out. At present there are no widely accepted methods for the large scale remediation of water or soils contaminated with PAH, PCB or pesticides.

The decomposition of PCB and organochloride compounds can be effected by high temperature incineration at a typical temperature of 1300° C. but the gaseous products must be quenched quickly to avoid the reformation of the PCB or the formation of undesirable side reaction products such as dioxins at 800-900° C. Such a process is complicated and with variable or uncertain outcomes.

Photocatalytic (UV) degration of contaminated soil-water systems has also been tried but is slow. Biodegradation of PCB, PAH and OP pesticides using micro-organisms such as bacteria or enzymes, or other chemical treatments are known. For example, PCB contaminated soils can be bio-remediated in a composting process in the presence of the right micro-organisms. These types of processes usually require lengthy operational time periods. The beneficial bacteria and enzymes can be consumed by other predatory micro-organisms or biota. Even more complicated is the situation where mixed systems of pesticides and other contaminants such as heavy metals (eg selenium or arsenic) are present. Although there may be appropriate biological species which can take up the metals from the environment (eg grasses or shrubs that are bred for this purpose), the presence of pesticides or herbicides retards the growth of the plants or even kills them.

Ultrasound is known in the art for inducing chemical reaction processes in liquids, a field known as sonochemistry. The propagation of ultrasonic waves in a liquid generates cavitation bubbles. These bubbles implode and produce micro-regions of extreme conditions. Estimated temperatures within these micro-regions range from 2000-5000K in aqueous solution. Our prior patent application published as WO02/22252 (now U.S. Pat. No. 6,908,559) relates to the chemical decomposition of compounds such as PCBs and pesticides, at the surface of a solid to which the compounds are absorbed, when ultrasound is applied.

It is to be understood that, if any prior art publication is referred to herein, such reference does not constitute an admission that the publication forms a part of the common general knowledge in the relevant art in any country.

### SUMMARY OF THE INVENTION

In a first aspect the present invention provides a process for treating a mixture of a solid and a liquid, the mixture including a contaminant, the process comprising the steps of:
subjecting the mixture to cavitation wherein at least a portion of the contaminant is chemically decomposed; and subsequently
introducing a pre-determined biological species into the treated mixture to give a desired biological outcome.

When the term “biological outcome” is used herein and throughout this specification, it is to be interpreted to include any biological or chemical process which can treat, remediate or decompose a relevant contaminant.

This process of the first aspect has the advantage of being able to treat contaminated liquid and solid mixtures to reduce the concentration of contaminants to a level so that biological or chemical treatment processes (such as biodegradation) can then operate to continue to reduce the concentration of contaminant to extremely low levels. If biological treatment was applied to a mixture with a high initial concentration of contaminant, the treatment may in all likelihood be ineffective in a reasonable time period because of the generally slow kinetics of biological treatment.

Also, in mixtures where a plurality of contaminants of different types are present, the rapid removal of a high concentration of one contaminant, which may otherwise have impeded the action of bioremediation of the other contaminant(s), can yield a specific biological outcome which may not have been able to be achieved.

The method can also be used to treat contaminants in the mixture where the “contaminant” can be a biological species such as an unwanted bacteria which is otherwise dominant or predatory on useful biological species. Cavitation can effectively decompose or destroy all of the bacteria present by acting as a biocide. Thereafter the purified mixture can have a given biological species introduced thereinto, such as a selected enzyme or different bacteria which have a specific biological purpose.

In one embodiment the cavitation can be effected by ultrasound. Ultrasound can provide for localised high temperatures followed immediately by a quenching of the decomposition products (that is, by the liquid) thereby avoiding the reformation of the substance or the formation of undesirable side reaction products at certain temperatures, as is the case with PCBs. The cavitation process may be effected by an ultrasonic treatment process using ultrasonic source equipment such as ultrasonic plates or probes located in a suitably arranged chamber.

In one embodiment the introduction of the biological species to give a desired biological outcome can result in at least one of a bio-remediation step (involving the introduction of a bacteria, enzyme or biota to chemically decompose a contaminant) or a phyto-remediation step (involving the use of certain plants to absorb the contaminant). In some instances other biological materials can also be added to the solid-liquid mixture for the purpose of supporting the bio-remediation or phyto-remediation step, for example such as fertiliser.

In one embodiment the process may also includes the step of aerating or oxygenating the mixture either before or after the introduction of the biological species. Aerobic conditions can to facilitate bio-remediation processes, for example, by encouraging bacterial or plant growth.

In one embodiment the process can also include the step of mixing the solid and liquid whereby the solid is substantially suspended in the liquid to increase exposure of the mixture to cavitation. The appropriate agitation of a solid and liquid mixture can thin lamellar boundary layers and provide particulate surface cleaning, so as to increase the effectiveness of both cavitation and the bio-remediation processes.

In one embodiment, the step of subjecting the mixture to cavitation can cause decomposition of the contaminant to a level below an acutely toxic level for a pre-determined biological species. In some situations the presence of an initial amount of contaminant can be fatal to plants or biological species, so by first using cavitation to decompose the contaminant to manageable, sub-toxic levels, the subsequent introduction of a pre-determined biological species can proceed successfully.

In one embodiment the step of subjecting the mixture to cavitation may also be preceded by the introduction of a pre-determined biological species into the mixture to be treated, for example an inoculum of a biological species such as a bacteria for use in a bio-remediation step to chemically decompose a contaminant. Depending on the resilience of the selected biological species, at least some of it may survive the cavitation step for later use to give a desired biological outcome in the treated mixture.

In one embodiment, the solid can include mineral and/or organic matter. The solid may include one or more materials such as silica, clay, carbonaceous material, activated carbon or calcium carbonate.

In one embodiment, at least some of the solid can serve to catalyse the chemical decomposition of the contaminant. Catalytic substrate materials can be introduced into a solid-liquid mixture for this purpose.

In one embodiment, the contaminant may be associated with the solid, and the chemical decomposition of the contaminant occurs at or near a surface of the solid. The method can most effectively treat contaminated solid particles at or around their surfaces, where the concentration of contaminants is at its highest when compared with the liquid phase.

In one embodiment, the contaminant may initially be located in the liquid and is adsorbed onto the solid in a step prior to cavitation. In some instances, this prior absorption of the contaminant from the liquid can increase the effectiveness of the decomposition of the contaminant.

In one embodiment when using ultrasound, the intensity of ultrasonic power used can exceed 100 Watts per square centimetre.

In one embodiment when using ultrasound, the ultrasonic power per unit volume used may be in the range of about 4 to 10 kilowatts per litre.

In a second aspect the present invention provides a cavitation apparatus adapted in use for receipt of a cavitation source, the apparatus comprising:
a first portion having a first cross-sectional area; and
a second portion in which the cavitation source is locatable to define a second cross-sectional area that is adjacent to the source;

wherein the first and second portions are arranged so that the in use first cross-sectional area is substantially the same as the second cross-sectional area.

The apparatus of the second aspect has the advantage that liquid and solid mixtures can be passed through the first and second portions at a generally constant flow rate because of the similarity in cross-sectional area throughout the apparatus. This can be important if solids are being carried in a fluid, as any change to the flowrate may cause solids to settle out of suspension, and possibly block the apparatus.

In one embodiment of the apparatus, the second cross-sectional area is annular around the cavitation source.

In one embodiment of the apparatus, the cavitation source can be an ultrasonic probe, although other ultrasonic tips or plates are also able to be used.

In one embodiment, the apparatus can be arranged for the passage of a flow of a fluid through the first and then the second portions so that in use the flow moves past the cavitation source.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 shows the experimental apparatus for treating a mixture of a solid and a liquid for the step of subjecting the mixture to cavitation, in accordance with the present invention;

FIG. 2 shows a view of a detail of a portion the embodiment of FIG. 1.

FIG. 3 shows some experimental results for the decomposition of pyrene in a soil slurry under the influence of sonication, in accordance with the present invention.

FIG. 4 shows some experimental results for the decomposition of tetrachloronapthalene under the influence of sonication at different slurry solids ratios, in accordance with the present invention.

### MODES FOR CARRYING OUT THE INVENTION

Exemplary processes will now be described for treating a solid-liquid mixture to decompose at least some of a contaminant associated with either the solid or the liquid by cavitation, followed by the step of introducing a pre-determined biological species into the treated mixture to give a desired biological outcome.

In such processes, the mixture being treated is usually made up of particulate solids suspended in the liquid, for example in the range of about 5%-50% w/w solids, although the mixture can even be in the form of a thick slurry or even a paste. The cavitation step can operate to decompose a contaminant that is adsorbed into the pores of the solid or onto the outer surface of the solid particles, or it may be that the contaminant is located only in the liquid, as a dissolved species. The effect of the cavitation can even be surmised to assist access to absorbed contaminants at a particulate solid by opening up narrow surface fissures.

Typically the contaminants of interest are polychlorinated biphenyl (PCB) compounds or a polybrominated biphenyl (PBB) derived from old plastic or electrical equipment, or a polycyclic aromatic hydrocarbon (PAH) byproduct from a hydrocarbon gas treatment process. Other contaminants studied includes pesticides and insecticides such as an organophosphate (OP), organochloride, carbaryl, synthetic pyrethroid or endosulfan as well as herbicides such as thiobencarb and molinate, amongst others.

The experimental procedure includes the step of subjecting the mixture to cavitation so that at least a portion of the contaminant is chemically decomposed. In one preferred embodiment, the cavitation is achieved using ultrasound, although other cavitation processes are applicable, for example high shear mixing.

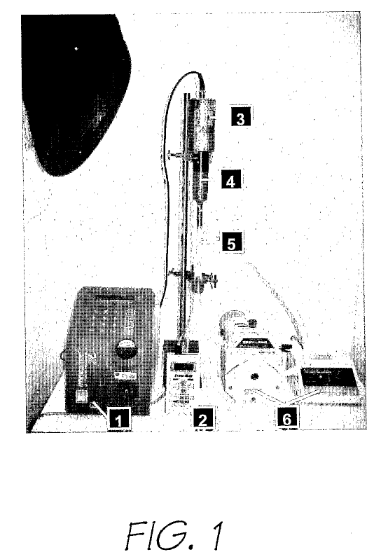

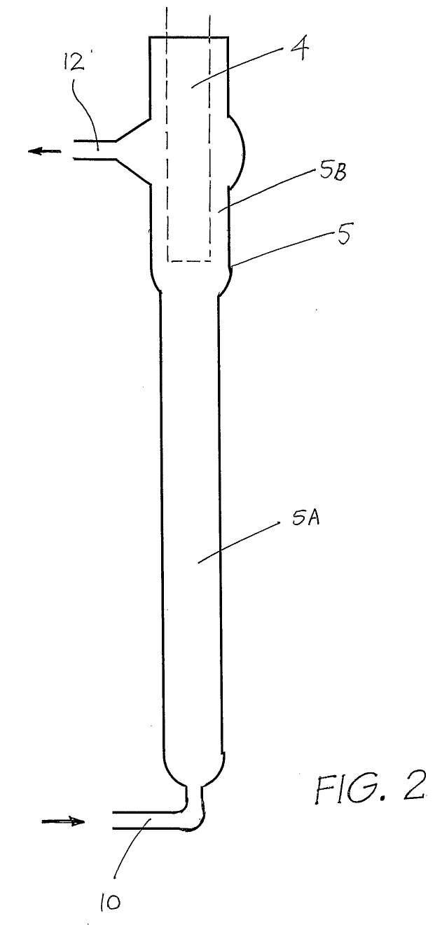

The experimental apparatus used is shown in FIGS. 1 and 2. A Misonix XL-2020 Sonicator (cell disrupter) 3 was used, powered by a power supply 1 and equipped with a 12.5-mm diameter, high intensity ultrasonic horn tip 4, which delivered up to approximately 160 W of power, at a frequency of 20 kHz. The power used was measured by a power meter 2. The piezoelectric transducer 3 and the tip 4 were coupled to the uppermost end of an elongate glass tube reactor 5 of circular cross-section. The solid slurry was pumped through a closed circuit using a peristaltic pump and a controller 6. The zone located below the ultrasonic tip (where the arrow 5 points) is called the reaction zone, where the highest cavitation activity takes place.

Referring to FIG. 2, the reactor 5 was designed to ensure a uniform slurry flow throughout its whole length and through the reaction zone, with the slurry flowing into the reactor 5 via a portal 10 at the base, upward through the reaction zone towards the horn tip 4, and then out of the reactor 5 via the side exit portal 12.

Referring to FIG. 2, the lower portion 5A of the reactor had a narrower inner diameter compared to the upper portion 5B of the reactor which houses the tip 4. When the tip 4 is located in the upper portion 5B, the annular cross-sectional area around the tip 4 through which slurry can flow is approximately the same as the cross-sectional area of the lower portion 5A of the reactor 5.

When using the apparatus shown in FIGS. 1 and 2, the inventor was able to deliver an intensity of ultrasonic power that exceeded 100 W/cm², and frequently reached as much as 160 W/cm². The apparatus was also able to be operated to deliver ultrasonic power per unit volume up to 10 kW/L, more usually around 4 kW/L.

The contaminated solid material was irradiated by ultrasound for various effective residence times in the reactor 5. Control samples (not sonicated) were recirculated through the system during a 3 minute period. At the end of each selected residence time, samples were collected in glass tubes lined with a Teflon or polytetrafluoroethene (PTFE) septum and stored at 4° C. until chemical analysis. The chemical analysis of the samples was carried out using an Agilent 6890 Series II Gas Chromatograph coupled to a Series 5970 Mass Selective Detector and a model 7683 Autosampler. The GC/MS was supported by its own system software, the MSD ChemStation, and the NIST (National Institute of Standards and Technology) mass spectral library.

The normal experimental procedure used will now be described in relation to a selected example. The soil used in this study was a sandy soil from Sydney, Australia. Its particle size distribution was 93.5% coarse-grained sand (1180-212 λm), 4.52% fine-grained sand (212-53 μm) and 1.98% silt and clay (<53 μm). The soil was air-dried and loosely broken apart by sieving (2 mm mesh sieve). The dried soil was then artificially contaminated with pyrene, a four-ringed PAH (sourced from the Sigma-Aldrich Chemical Company). This compound was added as an acetone solution, which was then given time to evaporate, yielding a final pyrene concentration of 400 mg kg⁻¹. The soil was introduced in the ultrasonic system as a slurry made with deionised water (10% solids by weight).

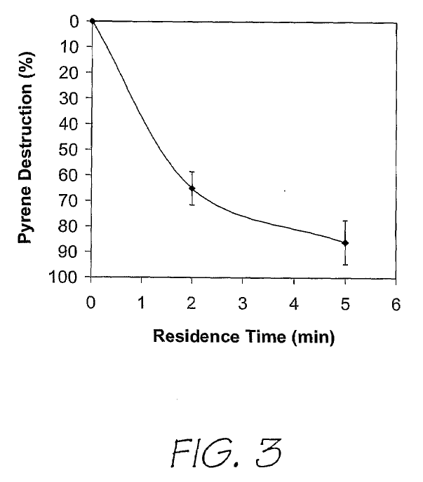

GC/MS analysis of soil samples before and after sonication evidenced a fast rate of pollutant destruction, and an ultrasonic exposure of 5 minutes destroyed 86% of the initial pyrene (FIG. 3). Tests showed that the ultrasonic treatment did not produce any toxic metabolites (or intermediate products) which could threaten the potential of coupling a bioremediation step after ultrasonic treatment.

Under the influence of ultrasound, the formation of a vapour bubble (as distinct from one formed from dissolved gases) occurs when stress in the liquid (due to the negative pressure produced during the expansion cycle of a sound wave) exceeds the tensile strength of the liquid. A vapour bubble can form in the liquid or at a solid-liquid boundary (at the surface of solids in a particle suspension or at the walls of a vessel, for example). Large amounts of energy are released from the cavitation collapse of vapour bubbles. When at or near to a solid surface, the manner of the bubble collapse takes the form of a high velocity jet directed at that surface. This effect is capable of achieving physico-chemical changes at the particle surface.

The localised high temperatures on bubble collapse (as high as 5000K) can decompose contaminant substances such as PAH, PCB and all of the others already mentioned. One of the advantages of the process for treatment of a slurry is that the decomposition products are quenched quickly down to the temperature of the bulk fluid (at, for example, 50° C.) which avoids the reformation of the PCB or PBB or the formation of undesirable metabolites and side-reaction products such as dioxins.

The ultrasonically-treated soil samples were then subjected to biodegradation of pyrene. This was compared with the results from some control sample examples. Duplicate soil samples (10 g) were placed in 250-milliliter Erlenmeyer flasks together with 100 μL of acetone solution, and homogenized for 72 hours. A sterile, inorganic salt solution was also added to complete a final volume of 100 mL. After the equilibration period, the soil slurries were inoculated with a pyrene-degrading strain (Mycobacterium gilvum VM552) and the biological treatment of the pyrene was determined by measuring the formation of ¹⁴CO₂ and by monitoring the residual levels of pyrene in the soil after bioremediation. Experiments over time (extending over some months) made in the presence of available oxygen showed a reduction in the remaining amount of pyrene as biodegradation took place. The inoculated bacteria thrived in the samples and slowly consumed the pyrene to very low levels so as to nearly completely remove the pollutant from the soil.

As an overall process, the initial ultrasonic treatment considerably reduced the treatment time and efficiency and, at the point when the effectiveness of the ultrasonic treatment started to plateau out, the bioremediation step followed as a “polishing” stage.

In further experiments using similar procedures, the chlorinated hydrocarbon insecticide Endosulfan was added to a soil sample to a final concentration of 200 mg kg⁻¹. The soil was introduced in the ultrasonic system and sonicated for 2 minutes to destroy about 80% of the initial amount present. Bioremediation then followed after sonication to slowly consume the pesticide down to very low levels. The removal of 80% of the Endosulfan by sonication represented a significant reduction in the acute toxicity of this insecticide, to the extent that bioremediation became both practicable and effective. Indeed with such a major reduction in the amount of pesticide present, the inventor also believes that, in this case, a phyto-remediation step may be achievable as the second stage. This would not normally be possible at the original concentration of Endosulfan pesticide present, which would very likely have killed plants, grasses and so on.

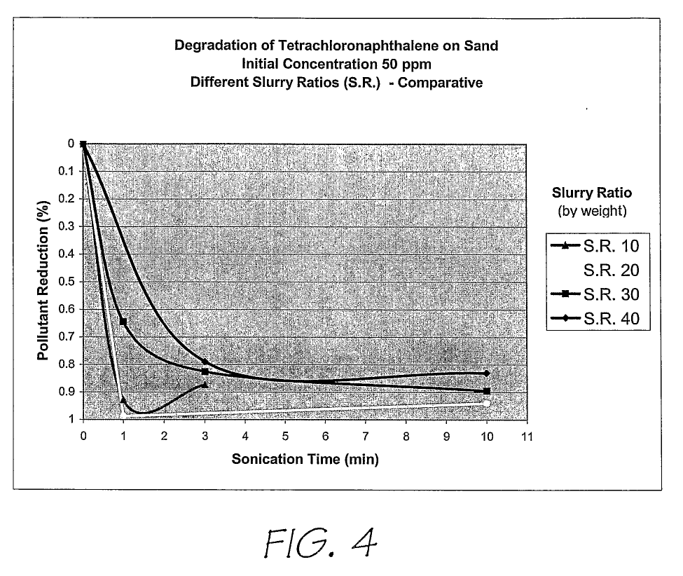

Some further data is presented in FIG. 4, where samples of sand which had been artificially contaminated with tetrachloronapthalene were irradiated by ultrasound for various effective residence times in the reactor that is shown in FIGS. 1 and 2. Samples taken before and after sonication showed a fast rate of pollutant destruction. An ultrasonic exposure of 10 minutes destroyed between 82 and 95% of the initial tetrachloronapthalene (FIG. 4). In particular, these tests generally showed that the most rapid reduction in contaminant, and the highest overall destruction of contaminant by ultrasound, is achieved using solid-liquid slurries having the lowest mass ratio of solids (lowest pulp density). This indicates that it may be more operationally more efficient to sonicate slurries with a pulp density in the lowest range prior to the subsequent step of introducing a bioremediation agent.

In alternative embodiments of the apparatus used for this process, sample contaminated slurries can be mixed by means of an impeller or similar stirring device in a mixing vessel such as a baffled tank to cause the slurry to become substantially suspended as well as to scour or clean the exposed solid surfaces by abrasion etc. With sufficient intensity, such stirring can itself create cavitation in the slurry. Stirring can maximise the exposure of the particle surfaces in the mixture to an external cavitation source. It is also possible that a solid-liquid mixture can be stirred simultaneously with application of cavitation, or as separate steps. The source of the cavitation is typically ultrasound from any suitable device that can be used to deliver sound waves of sufficient power and intensity, typically an ultrasonic bath, plate, probe source, or flow-through cell or other chambers.

In another embodiment, the mixture undergoing treatment can be aerated during agitation by bubbling or lancing air or oxygen-containing gas. Ideally this introduction of air is made before or after the introduction of the biological species into the liquid-solid mixture so that bacterial growth can be optimised. A plentiful supply of oxygen can eliminate competition for available oxygen so that growth rates of biological species are not inhibited. Other suitable stirring and oxygen delivery equipment is available in the minerals processing industry eg. flotation cells such as the Jameson™ cell, Wemco™ cell, etc.

The experiments conducted by the inventor have each involved soil (to mimic a soil remediation process) or sand as a neutral substrate. Normally in a soil remediation process some mineral and/or organic matter is also present, and the soil can include blends of one or more materials such as silica (sand), clay, carbonaceous material, activated carbon or calcium carbonate as well as organics in soils and sediments such as humic material etc.

In the usual circumstance, relatively insoluble contaminants such as PAH, PCB and the like are absorbed onto solid particles, and the chemical decomposition of the contaminant occurs at or near a surface of the solid particles. The cavitation step of the treatment process can most effectively treat contaminated solid particles at their surface where the concentration of contaminants is at its highest when compared with the liquid phase.

In some circumstances the PAH or PCB etc can initially be located in the liquid portion of a contaminated slurry. It is also envisaged that in some circumstances a liquid containing, for example, a pesticide can be brought into contact with solid particulates. In either case an agitation step prior to cavitation may be used, during which the contaminant in the liquid phase can become adsorbed onto the solid particles. Once absorbed from the liquid and onto the solid, the effectiveness of the decomposition of the contaminant undergoing cavitation is increased.

The porosity of the substrate can also influence the quantity of contaminant that is available for surface (or near-surface) reaction. Very adsorptive or porous substrates such as activated carbon or charcoal can adsorb a large quantity of a contaminant substance and make this material available at the surface for reaction.

The role of the solid substrate can also be to catalyse the decomposition of the contaminant, depending on the solid material present. It is possible to introduce catalytic solid materials into a feed slurry or pulp for this purpose. Known high temperature catalytic substrate materials can include, for example, titanium dioxide, vanadium oxide, chromic oxide and tungsten oxide although this is not an exhaustive list.

The cavitation step can thus treat a contaminated liquid and solid mixture to reduce the concentration of contaminant to such a level that a biological or chemical treatment process (eg biodegradation) can properly operate. Such a dual treatment arrangement can therefore reduce the concentration of contaminant to extremely low levels. Once the cavitation step is concluded, and the majority of a pesticide, for example, has been decomposed, a biological species can be introduced into the solid-liquid mixture. In the alternative, if a biological treatment was directly applied to a mixture with a high concentration of contaminant present, the bioremediation step may not work at all, or be ineffective in a reasonable time period because of the generally slow kinetics of biological treatment. Furthermore, the highest molecular weight contaminants in PAH-contaminated soils are generally not completely removed by biological treatment, whereas the present inventor has discovered that these contaminants are the first to be broken down in cavitation using ultrasound.

Enzymes are known which can decompose low concentrations of organophosphate pesticides. These enzymes can be employed with a normal degree of effectiveness to a mixture which has been ultrasonically treated, which may otherwise not be possible if used in the more highly contaminated mixture which is fed to cavitation. The desired biological outcome is the substantial decomposition of the pesticide. For example, an initial concentration of pesticide of 50 ppm may be reduced by 80% to 10 ppm after sonication, which can further be reduced by 90% to 1 ppm after bio-remediation using enzymes. Thus, the two-step process of the invention has been able to synergistically reduce the initial pesticide concentration by a total of 98%, where either process step alone is unlikely to have been as effective overall.

In the case of a solid-liquid mixture contaminated with a high level of PAH for example, the reduction in concentration of PAH effected by the cavitation can thus be followed up with the known use of ligninolytic enzymes found in white rot fungi to cause oxidation of low concentrations of PAHs such as anthracene, benzo(a)pyrene etc. The oxidation products of the PAH are more bioavailable for bacterial attack. The desired biological outcome in this case is the promotion of the sequential fungal-bacterial chemical decomposition of a substantial portion of the PAH.

Basidiomycetes have found use in the oxidative dechlorination of halomethanes, and may be used to degrade other chlorinated pollutants such as dioxins and PCB. Once again these species are only known to operate with feed materials having low concentrations of pollutants, so a prior cavitation step to decompose much of the PCB will achieve an improved overall degradation result.

In solid-liquid mixtures where a plurality of contaminants of different types are present, the rapid removal of a high concentration of one contaminant by cavitation (the presence of which may otherwise have impeded the action of bioremediation of the other contaminant), can yield a specific biological outcome which may not have been able to be achieved by other means. For example, cattle tick dip sites can be contaminated with a pesticide (such as DDT) and a heavy metal (such as arsenic). Whilst techniques for phyto-remediation of the arsenic are known involving the use of specially developed shrubs and grasses to absorb the arsenic during their growth (for example as dimethylarsenide in the leaves of bentgrass, or using white lupin or brakefern), the presence of the DDT pesticide can be fatal to these plants. By using cavitation to decompose the DDT to manageable levels first, the phyto-remediation can continue. In some of these cattle tick dip sites, the level of contamination of the soil particulates is anywhere up to 10% DDT by weight, which of course the biota and the arsenic-retaining plant life cannot survive unless substantial composition of the DDT occurs first.

The method can also be used to treat contaminants in solid-liquid mixtures where the “contaminant” can be a biological species such as an unwanted bacteria which is otherwise dominant or predatory on useful biological species. One of the principal factors which governs bio-degradation is the size of the indigenous microbial community. Protozoa are known to graze on bacteria, thereby having a major impact on the microbial community and the effectiveness of biological decomposition. Even if the correct selection of bacteria for the decomposition of a substance has been made, it may be that the local environment in which the bacteria is placed is hostile to that bacteria, reducing the effectiveness of any bio-remediation that can occur. Observations by the inventor have shown that an initial treatment by cavitation can effectively decompose or destroy all of the bacteria, protozoa and other microbes and organisms present in a mixture by acting as a biocide. This provides the option of selectively stocking the treated mixture with a range of organisms or biological species, such as a preferred enzyme or bacteria, which are targeted at decomposition of an undesirable substance in the mixture. The preferred enzymes can thus establish themselves in the mixture without competition from predatory species. Such selection of enzymes and micro-organic life in the final product may also be used to tailor the product, for example a soil, for specialist farming or agricultural uses.

Not only is this sort of technique applicable to solid-liquid mixtures contaminated with PAHs, for example, but could also find application in treating soils contaminated with heavy metals, such as selenium. Selected organisms can take up and digest selenium as part of their normal metabolism, so the prior use of ultrasound to eliminate predator organisms before introduction of the selenium-consuming bacteria is beneficial.

The method of the invention can also find application in treating soils which need remediation from animal-bourne diseases therein, such as anthrax, mad cow disease and the like. Once the disease organisms have been treated with cavitation in order to kill the pathogen or germ material, beneficial biological agents can be added to render the soil useful again.

Conceivably the process of the invention can be applied to in-situ site remediation applications where a pond, riverbed or harbourbed has been contaminated over a long period of time by PAHs, PCBs and the like. Depending on the concentration of contaminant substance in the feed mixture, the application of bioremediation treatments alone would be a very slow task. The present invention offers the alternative of a rapid reduction in contaminant concentration levels by using a cavitation stage followed by a bio-remediation or phyto-remediation stage in order to reach contaminant levels achievable only because of the combination.

Some of the other advantages of the treatment process include, but are not limited to, the following:
(i) the use of the cavitation stage to decompose pesticides or other toxic substances which otherwise would be fatal to plants involved in a subsequent phyto-remediation stage or to other organisms involved in a subsequent bio-remediation stage;
(ii) the option of selecting the most effective or desirable bio-remedial enzyme or bacteria, and ensuring that the biocide of predatory organisms reduces any interference in the action of this agent; and
(iii) the ability to perform the two-step process on or near site to avoid movement of contaminated materials over any great distances to a remote treatment facility, and the inherent costs and risks of such an operation.

Whilst the invention has been described with reference to a number of preferred embodiments it should be appreciated that the invention can be embodied in many other forms.

1-18. (canceled)

19. A process for treating a mixture of a solid and a liquid, the mixture including a contaminant, the process comprising the steps of:
subjecting the mixture to cavitation wherein at least a portion of the contaminant is chemically decomposed; and subsequently
introducing a predetermined biological species into the treated mixture to give a desired biological outcome.

20. A process for treating a mixture as claimed in claim 19, wherein the cavitation is effected by ultrasound.

21. A process for treating a mixture as claimed in claim 19, wherein the biological outcome is at least one of a bio-remediation or phyto-remediation step.

22. A process for treating a mixture as claimed in claim 19, further comprising the step of aerating or oxygenating the mixture either before or after the introduction of the biological species.

23. A process for treating a mixture as claimed in claim 19, further comprising the step of mixing the solid and liquid whereby the solid is substantially suspended in the liquid to increase exposure of the mixture to cavitation.

24. A process for treating a mixture as claimed in claim 19, wherein the step of subjecting the mixture to cavitation causes decomposition of the contaminant to a level below an acutely toxic level for a pre-determined biological species.

25. A process for treating a mixture as claimed in claim 19, wherein the step of subjecting the mixture to cavitation is preceded by the introduction of a predetermined biological species into the mixture to be treated.

26. A process for treating a mixture as claimed in claim 19, wherein the solid includes at least one of mineral and organic matter.

27. A process for treating a mixture as claimed in claim 19, wherein the solid includes one or more materials selected from the group consisting of silica, clay, carbonaceous material, activated carbon and calcium carbonate.

28. A process for treating a mixture as claimed in claim 19, wherein at least some of the solid serves to catalyse the chemical decomposition of the contaminant.

29. A process for treating a mixture as claimed in claim 19, wherein the contaminant is associated with the solid, and the chemical decomposition of the contaminant occurs proximate a surface of the solid.

30. A process for treating a mixture as claimed in claim 19, wherein the contaminant is initially located in the liquid and is adsorbed onto the solid in a step prior to cavitation.

31. A process for treating a mixture as claimed in claim 20, wherein the intensity of ultrasonic power used exceeds 100 Watts per square centimetre.

32. A process for treating a mixture as claimed in claim 20, wherein the ultrasonic power per unit volume used is in the range of about 4 to 10 kilowatts per litre.

33. A cavitation apparatus adapted in use for receipt of a cavitation source, the apparatus comprising:
a first portion having a first cross-sectional area; and
a second portion in which the cavitation source is locatable to define a second cross-sectional area that is adjacent to the source,
wherein the first and second portions are arranged so that the in use first cross-sectional area is substantially the same as the second cross-sectional area.

34. A cavitation apparatus as claimed in claim 33, wherein the second cross-sectional area is annular around the cavitation source.

35. A cavitation apparatus as claimed in claim 33, wherein the cavitation source is an ultrasonic probe.

36. A cavitation apparatus as claimed in claim 33, wherein the apparatus is arranged for the passage of a flow of a fluid through the first and then the second portions.
